(19) United States
(12) Patent Application Publication
(10) Pub. No.: US 2011/0090463 A1
(43) Pub. Date: Apr. 21, 2011

(54) PROJECTION APPARATUS

(75) Inventors: Ruei-Bin Jhang, Hsinchu (TW); Cheng-Shun Liao, Hsinchu (TW); Chu-Ming Cheng, Hsinchu (TW); Huang-Ming Chen, Hsinchu (TW); Chih-Hsien Tsai, Hsinchu (TW); S-Wei Chen, Hsinchu (TW)

(73) Assignee: YOUNG OPTICS INC., Hsinchu (TW)

(21) Appl. No.: 12/820,372

(22) Filed: Jun. 22, 2010

(30) Foreign Application Priority Data
Oct. 21, 2009 (TW) 98135642

(51) Int. Cl. G03B 21/28; G03B 21/14

(52) U.S. Cl. 353/31; 353/97; 353/38

(57) ABSTRACT

A projection apparatus includes at least one light source, a field lens, a light valve, and a projection lens. The light source provides an illumination beam. The field lens is disposed in a transmission path of the illumination beam including an effective beam passing through the field lens and a ghost beam reflected by the field lens. The light valve converts the effective beam into an image beam. The projection lens includes a lens group, an aperture stop, and a light-shielding element. The lens group and the aperture stop are disposed in a transmission path of the image beam passing through the field lens and a ghost beam path of the ghost beam reflected by the field lens. The light-shielding element is disposed in at least a portion of the ghost beam path between the lens of the lens group furthest away from the aperture stop and the aperture stop.

### CROSS-REFERENCE TO RELATED APPLICATION

This application claims the priority benefit of Taiwan application serial no. 98135642, filed on Oct. 21, 2009. The entirety of the above-mentioned patent application is hereby incorporated by reference herein and made a part of specification.

### BACKGROUND OF THE INVENTION

1. Field of the Invention

The invention relates to a projection apparatus, and particularly, to a projection apparatus capable of diminishing ghost images.

2. Description of Related Art

In a conventional projection apparatus with a field lens structure, a problem hard to solve is when an illumination beam is directly reflected by the field lens to a projection lens without passing through a light valve, unexpected light spots (i.e. ghost images) on a screen then occurs due to the reflected illumination beam. So far, a solution replying to the aforesaid problem is to increase an offset of a light valve with respect to a projection lens, or by using an optical thin film coating to diminish stray light (i.e. ghost image) resulting from the illumination beam being directly reflected by the field lens.

However, the methods have the following disadvantages. In the first method, the projection it is difficult to design lenses and the volume of the projection apparatus is increased as well. In the second method, since the reflectivity of the optical thin film coating may not reach 0%, slight ghost images still occurs, and the cost of the optical thin film coating is higher.

On the other hand, several projection apparatuses are provided. Taiwan Patent No. 00491364 discloses a projection apparatus consisting of an illumination optical system and an image forming system. The illumination optical system includes a light source and an illumination system, and the image forming system includes a field lens, an image-forming lens set, a stop, and a screen. The projection apparatus further includes at least one blade disposed in front of a surface of the field lens facing the light source, so as to shield or absorb a reflected beam resulting in ghost images.

Besides, Taiwan Patent No. 1264606 also discloses a projection apparatus, mainly including a light source system, a micro-mirror device, an image forming lens set, and a light-shielding sheet. The light-shielding sheet is disposed between the micro-mirror device and the image forming lens set to shield bias light, such that ghost images resulting from the bias light during image formation of the projection apparatus are avoided.

Moreover, Taiwan Patent No. 00560186 and U.S. Pat. No. 65,579,999 disclose an image projection system having a reflective imaging device and a projection device. The image projection system is characterized in that a quarter wave plate is provided between the reflective imaging device and projection lens so as to suppress reflections from the projection lens from reaching the reflective imaging device.

### SUMMARY OF THE INVENTION

The invention provides a projection apparatus. The projection apparatus utilizes a light-shielding element to shield stray light such that ghost images are effectively reduced.

Other objects and advantages of the invention may be further understood by referring to the technical features broadly embodied and described as follows.

In order to achieve at least one of the above advantages or other advantages, an embodiment of the invention provides a projection apparatus including at least one light source, a field lens, a light valve, and a projection lens. The light source is capable of providing an illumination beam. The field lens is disposed in a transmission path of the illumination beam which includes an effective beam and a ghost beam. The transmission path of the illumination beam includes an effective beam path and a ghost beam path. The effective beam is capable of being transmitted along the effective beam path and passing through the field lens. The ghost beam is capable of being transmitted along the ghost beam path and reflected by the field lens. The light valve is disposed in the effective beam path of the effective beam passing through the field lens and capable of converting the effective beam into an image beam, wherein the image beam is capable of passing through the filed lens. The projection lens includes a first lens group, an aperture stop, and a first light-shielding element. The first lens group is disposed in a transmission path of the image beam passing through the field lens and disposed in the ghost beam path of the ghost beam reflected by the field lens. The aperture stop is disposed in the transmission path of the image beam and the ghost beam path of the ghost beam reflected by the field lens, and located between the light valve and the first lens group. The first lens group includes a first lens furthest away from the aperture stop. Besides, the first light-shielding element is disposed in at least a portion of the ghost beam path between the first lens and the aperture stop.

Based on the above, in the projection apparatus of the embodiment of the invention, the light-shielding element shields at least a portion of the ghost beam reflected by the field lens, so as to diminish unexpected light spots (i.e. ghost images) on a screen resulting from the ghost beam.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic three-dimensional view of a projection apparatus according to the first embodiment of the invention.

FIG. 2A is a top view of the projection apparatus of FIG. 1.

FIG. 2B is a schematic cross-sectional view, along the yz-plane, of the lens array module as seen in the x-direction of FIG. 1.

FIG. 3 is a schematic cross-sectional view, along the xz-plane, of the projection lens, the field lens, and the light valve as seen in the y-direction of FIG. 1.

FIG. 4 is a schematic cross-sectional view, along the yz-plane, of the light source, the lenses, and the light-shielding element as seen in the x-direction of FIG. 1.

FIG. 5 is a schematic three-dimensional view of a projection apparatus according to the second embodiment of the invention.

FIG. 6A is a schematic three-dimensional view of a projection apparatus according to the third embodiment of the invention.

FIG. 6B is a schematic cross-sectional view, along the yz-plane, of the light source, the integration rod, and the light-shielding element as seen in the x-direction of FIG. 6A.

FIG. 7 is a top view of a projection apparatus according to the fourth embodiment of the invention.

### DESCRIPTION OF EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

### First Embodiment

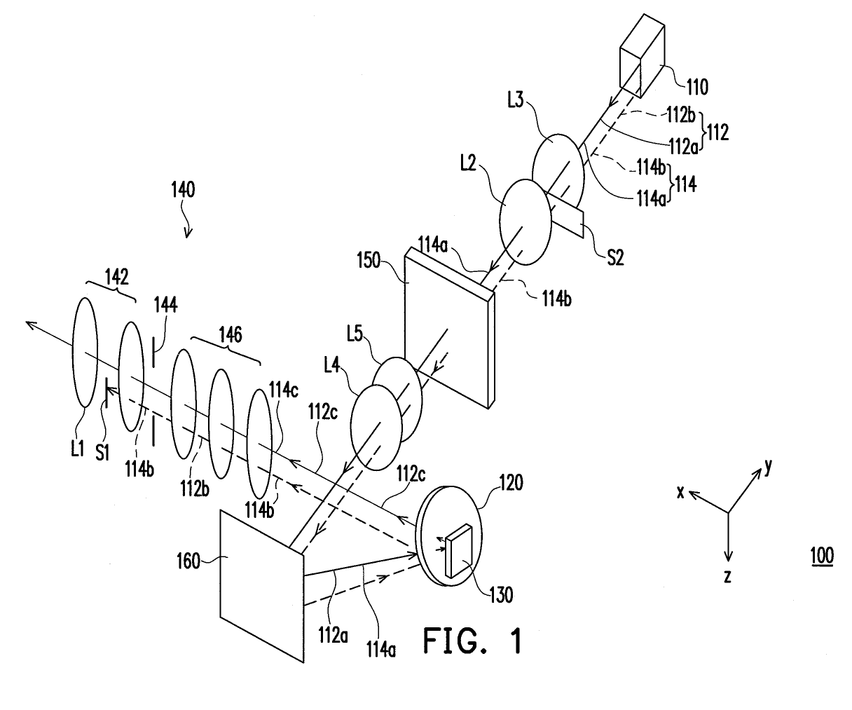

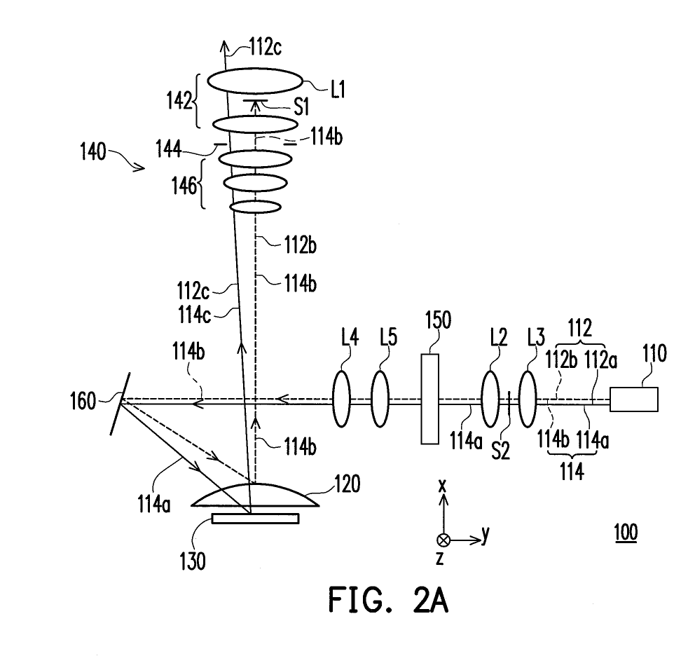

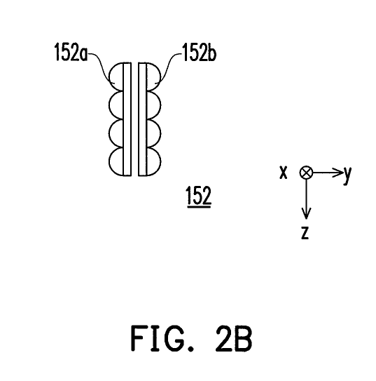

Please refer to both FIG. 1 and FIG. 2. The projection apparatus 100 of the embodiment includes at least one light source 110 (only one is schematically shown in FIG. 1), a field lens 120, a light valve 130, and a projection lens 140.

The light source 110 is capable of providing an illumination beam 112. In the embodiment, the light source 110 is, for example, a light emitting diode (LED). However, in another embodiment, the light source 110 may be an ultra high pressure lamp (UHP lamp) or other appropriate light source. The field lens 120 is disposed in a transmission path 114 of the illumination beam 112, wherein the illumination beam 112 includes an effective beam 112a and a ghost beam 112b. The transmission path 114 of the illumination beam 112 includes an effective beam path 114a and a ghost beam path 114b. As shown in FIGS. 1 and 2A, the effective beam 112a is capable of being transmitted along the effective beam path 114a and passing through the field lens 120. The ghost beam 112b is capable of being transmitted along the ghost beam path 114b and reflected by the field lens 120.

The light valve 130 is disposed in the effective beam path 114a of the effective beam 112a passing through the field lens 120, and is a digital micro-mirror device (DMD), for example. However, in other embodiments, the light valve may be a liquid-crystal-on-silicon panel (LCOS panel). The light valve 130 is capable of converting the effective beam 112a into an image beam 112c, and the image beam 112c is capable of passing through the filed lens 120. The projection lens 140 includes a lens group 142, an aperture stop 144, and a light-shielding element S1. According to the embodiment, the light-shielding element S1 is, for example, a light-shielding sheet.

As shown in FIGS. 1 and 2A, the lens group 142 is disposed in a transmission path 114c of the image beam 112c passing through the field lens 120 and disposed in the ghost beam path 114b of the ghost beam 112b reflected by the field lens 120. The aperture stop 144 is disposed in the transmission path 114c of the image beam 112c and the ghost beam path 114b of the ghost beam 112b reflected by the field lens 120, and located between the light valve 130 and the lens group 142. The lens group 142 includes a lens L1 furthest away from the aperture stop 144.

On the other hand, the light-shielding element S1 is disposed in at least a portion of the ghost beam path 114b between the lens L1 and the aperture stop 144. After the ghost beam 112b and the image beam 112c pass through the aperture stop 144, the transmission paths 114b and 114c of the two beams 112b and 112c are separated from each other remarkably. Thus, the light-shielding element S1 behind and under the aperture stop 144 shields the ghost beam 112b effectively without affecting the transmission of image beam 114c. Herein the backward direction represents the x-direction in FIG. 1, and the downward direction represents the z-direction. Besides, the z-direction is also an offset direction of the light valve 130 with respect to the projection lens 140. As a result, the light-shielding element S1 then reduces unexpected light spots (i.e. ghost images) on a screen (not shown) resulting from stray light (i.e. the ghost beam 112b).

Moreover, as shown in FIGS. 1 and 2A, the projection lens 140 of the embodiment may further includes a lens group 146. The lens group 146 is disposed in the transmission path 114c of the image beam 112c passing through the field lens 120 and in the ghost beam path 114b of the ghost beam 112b reflected by the field lens 120, and located between the aperture stop 144 and the field lens 120. Besides, the projection apparatus 100 may further include a lens L2, a light uniforming element 150, and a light-shielding element S2. According to the embodiment, the light-shielding element S2 is, for example a light-shielding sheet.

The lens L2 is disposed in the effective beam path 114a and the ghost beam path 114b, and located between the light source 110 and the filed lens 120. The light uniforming element 150 is disposed in the effective beam path 114a and in the ghost beam path 114b, and located between the lens L2 and the filed lens 120. In the embodiment, the light uniforming element 150 is, for example, a lens array module or a light integration rod. As shown in FIG. 2B, the lens array module 152 includes two lens array 152a and 152b, and is used to uniform the illumination beam 112 after the illumination beam 112 passes through the lens array module 152.

Please refer to FIGS. 1 and 2A. The light-shielding element S2 is disposed in at least a portion of the ghost beam path 114b between the light source 110 and the lens L2. In addition, the projection apparatus 100 of the embodiment may further include a lens L3. The lens L3 is disposed in the effective beam path 114a and the ghost beam path 114b, and located between the light source 110 and the light-shielding element S2. The function of the light-shielding element S2 is similar to the function of the light-shielding element S1, i.e. shielding at least a portion of the ghost beam 114b. In other embodiments, the lens L3 may be located between the lens L2 and the light uniforming element 150. From another aspect, the light-shielding element S2 may be disposed between the lens L3 and the light source 110 in FIG. 1. Alternatively, in other embodiments, the light-shielding element S2 may be disposed between the lens L2 and the light uniforming element 150 in FIG. 1.

Moreover, as shown in FIGS. 1 and 2A, the projection apparatus 100 further includes two lenses L4 and L5 disposed between the light uniforming element 150 and the field lens 160. Besides, the projection apparatus 100 of the embodiment also includes a reflective element 160. The reflective element 160 is disposed in the transmission path 114 of the illumination beam 112, and located between the light source 110 and the filed lens 120, so as to reflect the illumination beam 112 from the light source 110 to the field lens 120. The ghost beam 112b of the illumination beam 112 is reflected by the field lens 120, and the effective beam 112a thereof passes through the field lens 120 and is transmitted to the light valve 130. Then, the effective beam 112a passing through the light valve 130 is converted into the image beam 112c with image information. When the image beam 112c passes through the projection lens 140 to a screen (not shown), an image (not shown) is generated on the screen.

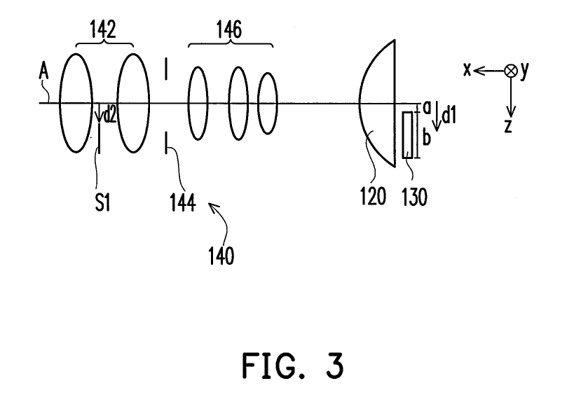

In the embodiment, an offset direction d1 of the light valve 130 with respect to an optical axis A of the projection lens 140 is substantially the same as a direction d2 from the optical axis A of the projection lens 140 to the light-shielding element S1 (i.e. the z-direction in FIG. 3). By adjusting the position of the light-shielding element S1, at least a portion of the ghost beam 112b is shielded such that unexpected stray light projecting on a screen (not shown) is reduced. Furthermore, if a distance between the optical axis A and the light valve 130 is a, and the width of the light valve 130 along the z-direction is b (as shown in FIG. 3), an offset between the light valve 130 and the projection lens 140 is defined as (a+b/2)/(b/2).

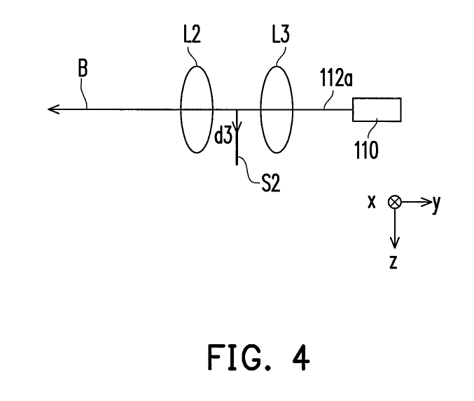

Similarly, in the embodiment, a direction d3 from an optical axis B of the effective beam 112a to the light-shielding element S2 is substantially the same as the offset direction d1 of the light valve 130 with respect to the optical axis A of the projection lens 140 (i.e. the z-direction in FIGS. 3 and 4). Referring to both FIGS. 1 and 4, the function of the light-shielding element S2 is similar to the function of the light-shielding element S1, i.e. effectively shielding at least a portion of the ghost beam 112b. However, the position of the light-shielding element S2 is not limited to the embodiment. The direction from an optical axis B of the effective beam 112a to the light-shielding element S2 may be substantially opposite to the offset direction d1 of the light valve 130 with respect to the optical axis A of the projection lens 140 (i.e. the negative z-direction in FIGS. 3 and 4). Besides, in other embodiments, the projection apparatus 100 may not include the light-shielding element S2.

### Second Embodiment

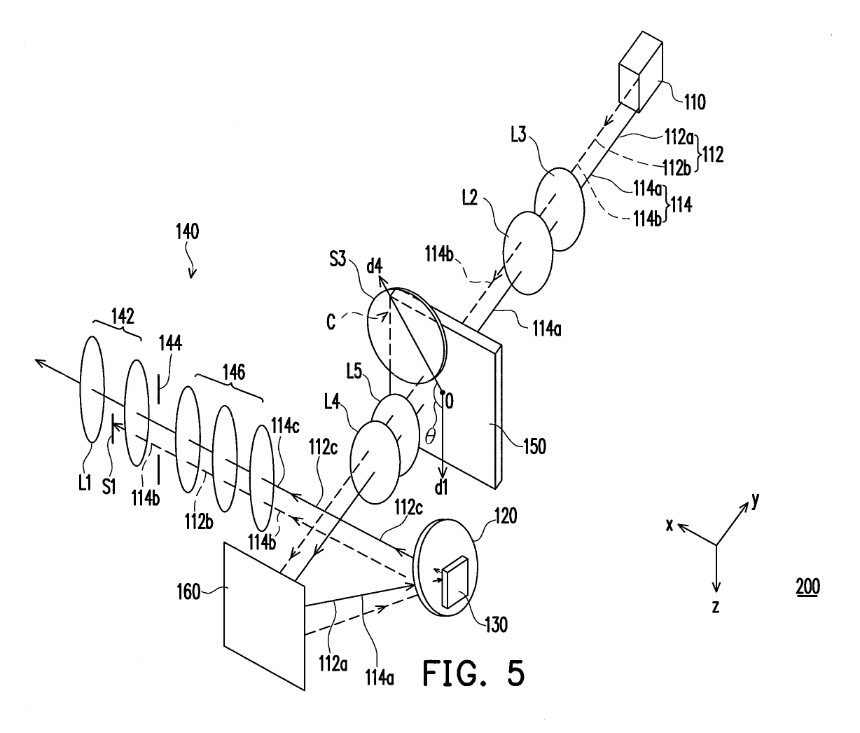

The projection apparatus 200 of the embodiment is similar to the projection apparatus 100, while the major difference therebetween lies in the light-shielding element S3 of the projection apparatus 200 covers a corner C of the light uniforming element 150, wherein the light uniforming element 150 of the embodiment is the lens array module 152 (as shown in FIG. 2B), and the light-shielding element S3 is, for example a light-shielding sheet. As shown in FIG. 5, the projection lens 140 is closer to the corner C than to a center O of the lens array module 152. Please refer to both FIG. 3 and FIG. 5. An included angle θ between a direction d4 from the center O of the lens array module 152 to the corner C and the offset direction d1 of the light valve 130 with respect to the optical axis A of the projection lens 140 is greater than 90 degrees and smaller than 180 degrees.

On the other hand, the projection apparatus 200 of the embodiment further includes a lens L4 disposed in the effective beam path 114a and the ghost beam path 114b. As shown in FIG. 5, the light-shielding element S3 is disposed in at least a portion of the ghost beam path 114b between the light uniforming element 150 and the lens L4. The lens L4 is located between the light uniforming element 150 and the field lens 120. Moreover, the projection apparatus 200 further includes a lens L5 disposed in the effective beam path 114a and the ghost beam path 114b, and located between the lens L4 and the light-shielding element S3. In other embodiments, the lens L5 may be located between the light-shielding element S3 and the light uniforming element 150, and the light-shielding element S3 also covers the corner C of the light uniforming element 150. However, the position of the light-shielding element S3 is not limited to the embodiment. The light-shielding element S3 may be disposed in at least a portion of the ghost beam path 114b between the light uniforming element 150 and the lens L2.

### Third Embodiment

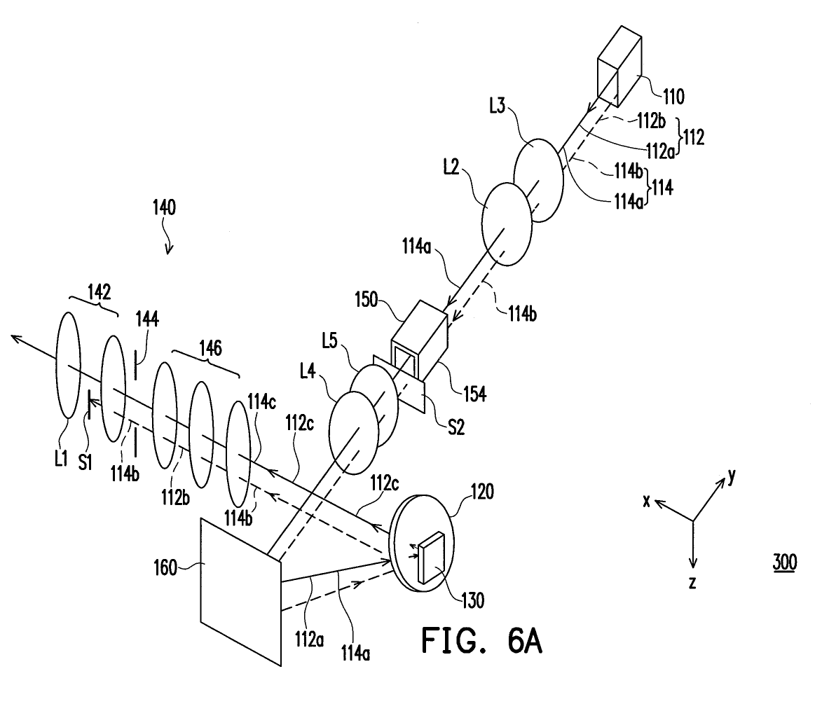

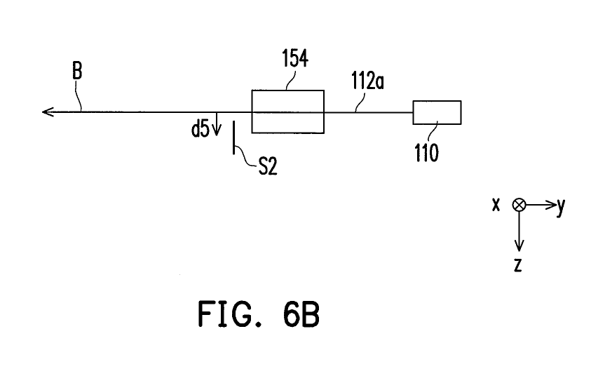

Please refer to FIG. 6A. The projection apparatus 300 of the embodiment is similar to the projection apparatus 200, while the major difference therebetween lies in the light uniforming element 150 of the projection apparatus 300 is a light integration rod 154, and the light-shielding element S2 covers a downward side of a light emitting side of the light integration rod 154. Please refer to FIGS. 6B and 3. A direction d5 from the optical axis B of the effective beam 112a to the light-shielding element S2 is substantially the same as the offset direction d1 of the light valve 130 with respect to the optical axis A of the projection lens 140 (i.e. the z-direction).

On the other hand, referring to FIG. 6A, the light-shielding element S2 is disposed in at least a portion of the ghost beam path 114b between the light uniforming element 150 and the lens L4. Furthermore, the lens L5 of the embodiment is located between the light-shielding element S2 and the lens L4. However, in other embodiments, the lens L5 of the embodiment may be located between the light-shielding element S2 and the light uniforming element 150.

### Fourth Embodiment

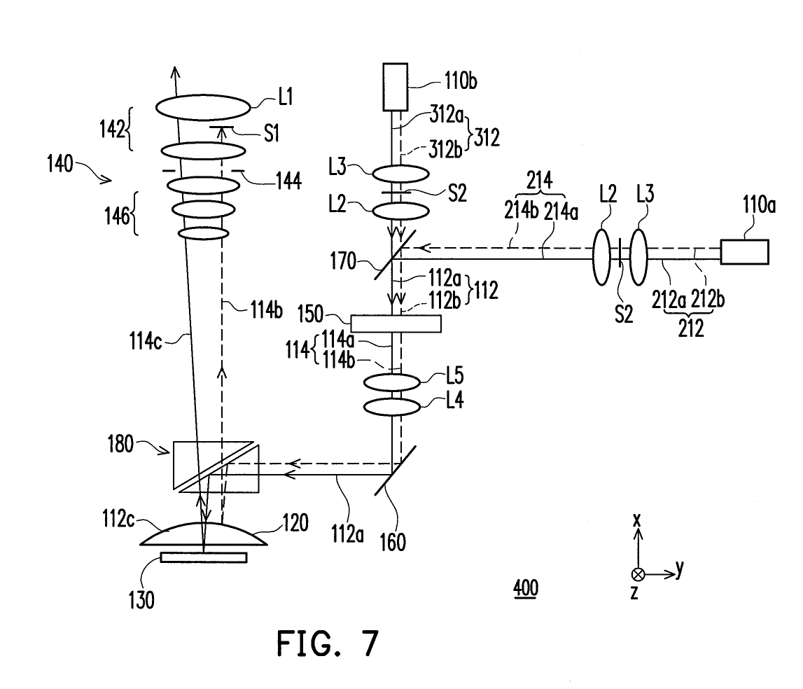

The projection apparatus 400 of the embodiment is similar to the projection apparatus 100 of FIG. 2A, while the major difference therebetween lies in that the projection apparatus 400 includes a plurality of light sources 110a and 110b (only two are schematically shown in FIG. 7), a beam combining unit 170, and a total internal reflection (TIR) prism 180.

The light sources 110a and 110b are, for example, light sources emitting beams with different colors. The beam combining unit 170 is disposed in a transmission path 214 of an illumination beam 212 provided by the light source 110a, and disposed in a transmission path 314 of the illumination beam 312 provided by the light source 110b. Besides, the beam combining unit 170 is located between each of the light sources and the filed lens 120, so as to combine the transmission paths 214 and 314 of the illumination beams 212 and 312. Thus, an illumination beam same as the illumination beam 112 of FIG. 2A is formed. The illumination beam 112 includes the effective beam 112a and the ghost beam 112b.

Specifically, the beam combining unit 170 reflects the effective beam 212a and the ghost beam 212b from the light source 110a to the light uniforming element 150. On the other hand, the effective beam 312a and the ghost beam 312b from the light source 110b pass through the beam combining unit 170 and is transmitted to the light uniforming element 150. Thus, an illumination beam same as the illumination beam 112 of FIG. 2A is formed. Besides, the beam combining unit 170 of the embodiment is, for example a dichroic unit. Then, the reflective element 160 reflects the illumination beam 112 to the TIR prism 180. The TIR prism 180 is disposed in the transmission path of the illumination beam 114, and located between the light source 110a (or the light source 110b) and the field lens 120.

As shown in FIG. 7, the effective beam 112a sequentially passes through the field lens 120 and the light valve 130 after being totally reflected by the TIR prism 180, such that the image beam 112c is generated. Then, the image beam 112c is transmitted to the projection lens 140 from the inner TIR prism 180 after passing through the field lens 120 such that an image (not shown) is formed on a screen (not shown). In brief, in terms of the transmission path of a beam, the TIR prism 180 is disposed in the transmission path 114c of the image beam 112c and located between the field lens 120 and the projection lens 140.

On the other hand, the projection apparatus 400 of the embodiment includes two light-shielding elements S2, two lenses L2, and two lenses L3, and the two lenses L2 and the two lenses L3 respectively corresponds to the light sources 110a and 110b. The relative positions of the light-shielding element S2 and the lens L3 are the same as that in the first embodiment, and may be deduced by referring to FIGS. 3 and 4. Thus, the detailed descriptions are omitted. In brief, a direction from the optical axis of the effective beam 212a emitting from the light source 110a to the light-shielding element S2 is substantially the same as the offset direction of the light valve 130 with respect to the optical axis of the projection lens 140. As a result, the two light-shielding elements S2 are capable of respectively shielding at least a portion of the ghost beam 212b from the light source 110a and at least a portion of the ghost beam 312b from the light source 110b, such that unexpected light spots on a screen are diminished.

Based on the above, the projection apparatus of the embodiment of the invention utilizes the light-shielding element to shield at least a portion of the ghost beam (i.e. stray light) directly reflected by the field lens, such that unexpected light spots (i.e. ghost images) resulting from the ghost beam projecting on a screen during image formation are reduced. In other words, since the light-shielding element shields, at least a portion of the ghost beam, ghost images on a screen are diminished.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projection apparatus, comprising:
at least one light source, capable of providing an illumination beam;
a field lens, disposed in a transmission path of the illumination beam, the illumination beam comprising an effective beam and a ghost beam, the transmission path of the illumination beam comprising an effective beam path and a ghost beam path, wherein the effective beam is capable of being transmitted along the effective beam path and passing through the field lens, and the ghost beam is capable of being transmitted along the ghost beam path and reflected by the field lens;
a light valve, disposed in the effective beam path of the effective beam passing through the field lens and capable of converting the effective beam into an image beam, wherein the image beam is capable of passing through the filed lens; and
a projection lens, comprising:
a first lens group, disposed in a transmission path of the image beam passing through the field lens and disposed in the ghost beam path of the ghost beam reflected by the field lens;
an aperture stop, disposed in the transmission path of the image beam and the ghost beam path of the ghost beam reflected by the field lens, and located between the light valve and the first lens group, wherein the first lens group comprises a first lens furthest away from the aperture stop; and
a first light-shielding element, disposed in at least a portion of the ghost beam path between the first lens and the aperture stop.

2. The projection apparatus of claim 1, wherein an offset direction of the light valve with respect to an optical axis of the projection lens is substantially the same as a direction from the optical axis of the projection lens to the first light-shielding element.

3. The projection apparatus of claim 1, further comprising:
a second lens, disposed in the effective beam path and the ghost beam path, and located between the light source and the filed lens;
a light uniforming element, disposed in the effective beam path and the ghost beam path, and located between the second lens and the filed lens; and
a second light-shielding element, disposed in at least a portion of the ghost beam path between the light source and the second lens.

4. The projection apparatus of claim 3, wherein a direction from an optical axis of the effective beam to the second light-shielding element is the same as or opposite to an offset direction of the light valve with respect to an optical axis of the projection lens.

5. The projection apparatus of claim 3, further comprising a third lens, disposed in the effective beam path and the ghost beam path, and located between the light source and the second light-shielding element.

6. The projection apparatus of claim 3, further comprising a third lens, disposed in the effective beam path and the ghost beam path, and located between the second lens and the light uniforming element.

7. The projection apparatus of claim 1, further comprising:
a light uniforming element, disposed in the effective beam path and the ghost beam path, and located between the light source and the filed lens;
a third lens, disposed in the effective beam path and the ghost beam path, and located between the light uniforming element and the filed lens; and
a third light-shielding element, disposed in at least a portion of the ghost beam path between the light uniforming element and the third lens.

8. The projection apparatus of claim 7, wherein the light uniforming element is a light integration rod, and a direction from an optical axis of the effective beam to the third light-shielding element is the same as or opposite to an offset direction of the light valve with respect to an optical axis of the projection lens.

9. The projection apparatus of claim 7, wherein the light uniforming element is a lens array module, the third light-shielding element covers a corner of the lens array module, the projection lens is closer to the corner than to a center of the lens array module, and an included angle between a direction from the center of the lens array module to the corner and the offset direction of the light valve with respect to the optical axis of the projection lens is greater than 90 degrees and smaller than 180 degrees.

10. The projection apparatus of claim 7, further comprising a fourth lens, disposed in the effective beam path and the ghost beam path, and located between the third light-shielding element and the light uniforming element.

11. The projection apparatus of claim 7, further comprising a fourth lens, disposed in the effective beam path and the ghost beam path, and located between the third lens and the third light-shielding element.

12. The projection apparatus of claim 1, further comprising a reflective element, disposed in the transmission path of the illumination beam and located between the light source and the filed lens to reflect the illumination beam from the light source to the field lens.

13. The projection apparatus of claim 1, further comprising a total internal reflection prism, disposed in the transmission path of the illumination beam, and located between the light source and the field lens, wherein the total internal reflection prism is disposed in the transmission path of the image beam, and located between the field lens and the projection lens.

14. The projection apparatus of claim 1, further comprising a second lens group, disposed in the transmission path of the image beam passing through the field lens and the ghost beam path of the ghost beam reflected by the field lens, and located between the aperture stop and the field lens.

15. The projection apparatus of claim 1, wherein the at least one light source is a plurality of light sources, and the projection apparatus further comprises a beam combining unit which is disposed in transmission paths of illumination beams provided by the light sources and is located between each of the light sources and the filed lens so as to combine the transmission paths of the illumination beams.

16. The projection apparatus of claim 15, wherein the beam combining unit is a dichroic unit, and colors of the illumination beams emitted from the light sources are different.
